(19) United States
(12) Patent Application Publication
(10) Pub. No.: US 2005/0281404 A1
(43) Pub. Date: Dec. 22, 2005

(54) Scalable streaming media authentication

(75) Inventor: Hong Heather Yu, Princeton Junction, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/870,872

(22) Filed: Jun. 17, 2004

(51) Int. Cl. H04L 9/00

(52) U.S. Cl. 380/28

(57) ABSTRACT

Consumer networks, increasingly used for multimedia information and commercial content delivery, are destined to be heterogeneous. To provide QoS, it is necessary to adapt the multimedia stream to the heterogeneous network channel conditions and device capabilities. Meanwhile, security is an important component to restrict unauthorized multimedia content access and distribution. This suggests the need for new cryptography system implementations that can operate at different data rates, i.e., be scaled to various multimedia content, different network topology, changing bandwidth, and diverse receiver device capabilities. Content authentication is one important security tool for secure multimedia content communication. Conventional message authentication schemes do not offer suitable scalability for this new set of applications. The present invention addresses design of scalable media data stream authentication and presents a framework for multimedia authentication that supports various kinds of scalability.

### FIELD OF THE INVENTION

The present invention generally relates to streaming media, and particularly relates to scalable streaming media authentication systems and methods.

### BACKGROUND OF THE INVENTION

Considering the following application scenario: a streaming video server X streams premium video/audio content to clients with various playback devices, such as DTV, desktop PC, PDA, and cellular phone. To ensure authenticity of the premium content, the server authenticates each video before sending it to the clients; to provide quality of services for various devices in heterogeneous environment, it is desirable that the server sends the medium stream, at the rate suitable for the network channel condition and receiver device capability, to the client (see FIG. 1.) The client, upon receiving the video data stream, verifies the authenticity of it before playback. In such a system, data authentication and streaming pose challenges. If the server authenticates the media data stream using traditional crypto schemes and sends it to the receiver where it will be verified at the same rate, it requires correct reception of each and every bit of the original media data stream. To do that three or more assumptions are made: the channel capacity is known; the receiver playback device capability is known; and the receiver can receive all the bits correctly in time for verification and playback. However, due to the diverse device capability and channel capacity, the time constraint for real time and streaming media, the large size and bandwidth demand of multimedia objects, the often long duration (playback time) of media data stream, and error prone property of wireless channels, those assumptions are challenging. Suppose client A uses DTV to access video V1 and client B wants to access V1 with his mobile handheld device which operates at a substantially lower data rate compares to that of A's DTV. To authenticate and then stream V1 to both A and B using conventional cryptosystem [1] and media transmission technologies, the server needs to prepare and authenticate two different copies of video [2] V1: V1¹⊂V1 and V1²⊂V1 with different resolutions, one, V1¹, suitable for transmission through broadband wired network for high resolution playback on DTV; and another one, V1², scaled to the channel capacity of the corresponding wireless network and the device capability of the mobile device. Further, for streaming applications where the data streams are sent to the client for continuous playback without downloading the entire media data streams, partition on data stream is performed. That is each copy of the video V1^{d} is partitioned into blocks or packets V1^{d}=<V1^{d}(1), V1^{d}(2), . . . , V1^{d}(φ^{d}), . . . , V1^{d}(Φ^{d})>. Each block (packet) V1^{d}(φ^{d}), φ^{d}∈[1, Φ^{d}] and d∈[1, D], needs to be signed, preferably using public key crypto scheme. We shall call this approach signsimulcast using naïve stream authentication in the following discussion. Obviously, the number of singing operations at the server is proportional to the number of potential types of receiver devices, channel conditions, and the total number of packets (blocks) of all copies

$${\sum }_{d = 1}^{D} {Φ}^{d} .$$

The maximum number of verification operations at the client is proportional to Φ^{D}. These impose substantial server storage space requirement and/or real time computational overhead for the video authentication and verification. In some applications with a potentially large D, and a large Z (number of videos in the server), it can be too expensive or hard to manage. With low power mobile devices and potentially large Φ^{D} or potentially expensive public key crypto scheme, it could be infeasible for mobile multimedia applications. Accordingly, the need remains for efficient authentication systems and methods for scalable multimedia services. The present invention fulfills this need.

### SUMMARY OF THE INVENTION

In accordance with the present invention, efficient authentication for scalable multimedia services is achieved through a new set of authentication schemes that we call SMMA. In contrast to signsimulcast, a single authenticated media data stream is placed at the server and transmitted to clients. By jointly designing the coding, packetization, and authentication in a scalable fashion, quality adaptation, to the network condition and the receiver device capability, is achieved.

The present invention is advantageous over previous authentication schemes in several ways. First, it achieves scalability via a single authenticated data stream. Second, it offers multi-level scalability for multimedia transmission over heterogeneous networks. Third, it provides loss resilient scalability.

The following criteria are taken into consideration in the design of the algorithms: additional storage space (buffer size) and computational cost (power) required for scalable authentication should not exceed server (client) sustainable capacity. The algorithms should provide suitable scalability to the targeted application and network topology.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an entity relationship diagram illustrating a typical scenario of heterogeneous clients;

FIG. 2 is a block diagram of a targeted layered structure.

### DETAILED DESCRIPTION OF THE PREFERRED EMBODIMENTS

The following description of the preferred embodiment(s) is merely exemplary in nature and is in no way intended to limit the invention, its application, or uses.

Scalable streaming media authentication: Due to the time constraint of streaming media (SM), it is often more challenging to provide QoS for SM than that for downloaded media. In this section, we mainly focus our discussion on streaming media through packet switch network. For simplicity, we assume it is possible to reserve a constant C number of bits for extra authentication information in each packet of the multimedia data stream. We will discuss how to relax this requirement at the end of this detailed description. Further, we assume the receiver has the processing power to compute the one way hash faster than the incoming packet streaming rate so that the receiver will be able to reconstruct and play the stream at the same rate the streaming media would without authentication. We demonstrate the feasibility of this assumption below in a simulation section.

In the following discussion, we consider the cases of lossless transmission and lossy transmission respectively and design SMMA schemes accordingly.

Multi-Directional Backward authentication and forward verification (MDBAFV): In this section we consider the scenario where the receiver can always receive the packets in time and error free for playback, i.e., reliable communication can be established. We propose a 2D backward authentication and forward verification scheme and discuss how it can be used for scalable access of authenticated multimedia data streams.

Let's denote V the original media data stream at the server, H a collision resistant crypto hash function, Sign a secure digital signature function, V a verification function, and K_{enc} and K_{dec} the encryption and decryption key respectively.

The server structures the media data stream using layered organization. The original data stream to be transmitted at each time interval is split into base layer, which contains the most essential information for minimum acceptable playback quality, and J enhancement layers with optional enhancement information. For ease of discussion, let's assume each layer is packetized into one packet at the moment. Denote \hat{V}=<\hat{V}(1), \hat{V}(2), . . . , \hat{V}(T)> the structured media data stream, to be delivered at time t=t₁, t₂, . . . t_{T}. Assume \hat{V}(t) is partitioned into a base layer \hat{V}_{b}(t)=\hat{V}₀(t) and J enhancement layer segments (packets) \hat{V}ⱼ(t), each of size mbits, in a priority based order. We have

$$\begin{matrix}{V}^{⋒} = < {V}^{⋒} ( 1 ) , {V}^{⋒} ( 2 ) , … , {V}^{⋒} ( T ) > \\ = \vert \begin{matrix}{{V}^{⋒}}_{0} ( 1 ) & {{V}^{⋒}}_{0} ( 2 ) & … & {{V}^{⋒}}_{0} ( T ) \\ {{V}^{⋒}}_{1} ( 1 ) & {{V}^{⋒}}_{1} ( 2 ) & … & {{V}^{⋒}}_{1} ( T ) \\ ⋮ & ⋮ & … & ⋮ \\ {{V}^{⋒}}_{J} ( 1 ) & {{V}^{⋒}}_{J} ( 2 ) & … & {{V}^{⋒}}_{J} ( T )\end{matrix} \vert\end{matrix} \qquad ( 1 )$$

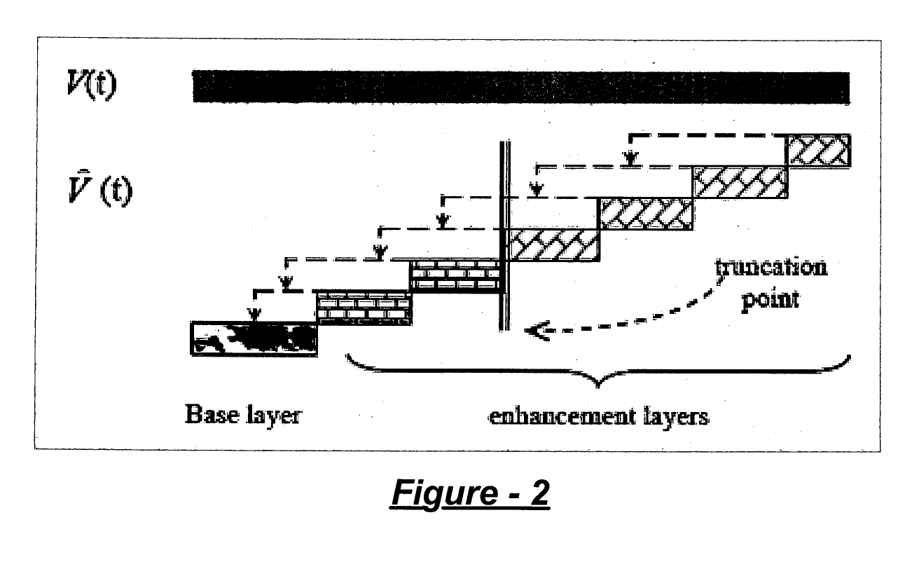

FIG. 2 illustrates the targeted layered structure.

The server performs MDBAFV(\hat{V}, K_{enc,} H, Sign) to generate the authenticated scalable media data stream:

$${{V}^{⋒}}^{′} = < S , {{V}^{⋒}}^{″} > \\ {{V}^{⋒}}^{″} = \vert \begin{matrix}{{V}^{⋒}}_{0}^{′} ( 1 ) & {{V}^{⋒}}_{0}^{′} ( 2 ) & … & {{V}^{⋒}}_{0}^{′} ( T ) \\ {{V}^{⋒}}_{1}^{′} ( 1 ) & {{V}^{⋒}}_{1}^{′} ( 2 ) & … & {{V}^{⋒}}_{1}^{′} ( T ) \\ ⋮ & ⋮ & … & ⋮ \\ {{V}^{⋒}}_{J}^{′} ( 1 ) & {{V}^{⋒}}_{J}^{′} ( 2 ) & … & {{V}^{⋒}}_{J}^{′} ( T )\end{matrix} \vert \qquad ( 2 )$$

as follows where S is the server signature:
Perform:

$$For t = T to 1$$

$$For j = J to 0$$

$$\begin{matrix}\{ \begin{matrix}{{V}^{⋒}}_{j}^{′} ( t ) = < {{V}^{⋒}}_{j} ( t ) , {V}_{0} > , if j = J and t = T \\ {{V}^{⋒}}_{j}^{′} ( t ) = < {{V}^{⋒}}_{j} ( t ) , {h}_{j} ( t + 1 ) > , if j = J and t \neq T \\ {{V}^{⋒}}_{j}^{′} ( t ) = < {{V}^{⋒}}_{j} ( t ) , {h}_{j + 1} ( t ) , {V}_{0} > , if j = 0 and t = T \\ {{V}^{⋒}}_{j}^{′} ( t ) = < {{V}^{⋒}}_{j} ( t ) , {h}_{j + 1} ( t ) , {h}_{j} ( t + 1 ) > , if j = 0 and t \neq T \\ {{V}^{⋒}}_{j}^{′} ( t ) = < {{V}^{⋒}}_{j} ( t ) , {h}_{j + 1} ( t ) > , otherwise\end{matrix} & ( 3 \text{-} 1 ) \\ {h}_{j} ( t ) = H ( {{V}^{⋒}}_{j}^{′} ( t ) ) \\ {h}_{0} = < {h}_{0} ( 1 ) , J , m , m 0 > & ( 4 \text{-} 1 ) \\ {{V}^{⋒}}_{0}^{′} ( 0 ) = S = < {h}_{0} , Sign ( {h}_{0} , {K}_{enc} ) > & ( 5 \text{-} 1 )\end{matrix}$$

Upon receiving a streaming request, the server looks up for the desired stream. On a server hit, the server sends the data stream packet by packet to the client. At time tₜ, the packets are sent in the order of \hat{V}′₀(t), \hat{V}′₁(t), . . . In the case that the bandwidth of the playback session at the receiver Br equals to that of the base layer stream B_{b}, Bᵣ=B_{b}, the client first receives \hat{V}′₀(0) and verifies the authenticity of it
v=V(\hat{V}′₀(0),K_{dec}) (6)
It then extracts h₀(1) if v=1; otherwise stop streaming and restart the session. The client starts reconstruction upon receiving the second packet \hat{V}′₀(1) and verifying that \hat{V}′₀(1) is authentic using h₀(1) extracted from \hat{V}′₀(0) and h′₀(1) calculated with eq (4-1). Because the verification of subsequent packets at time t=2 to T does not require computing the expensive signature but only a much faster one way hash, the computational overhead is dramatically saved. Since we assume that the receiver has the processing power to compute the one way hash faster than the incoming packet streaming rate, the receiver will be able to reconstruct and play the stream at the same rate the streaming media data stream would without authentication. This is precisely what we want to achieve. The initial playback delay τ equals the delay for streaming without authentication τ₁ plus τ₀, the time for receiving \hat{V}′₀(0) and verifying it: τ=τ₀+τ₁.

When Bᵣ>B_{b}, the receiver needs to fetch the base layer plus some of the enhancement layer data stream. Assume J′<J additional enhancement layers are fetched from the server. The receiver starts verification similar to that of the above case. Upon receiving the second to the (J*+1)th packets: \hat{V}′₀(1), \hat{V}′₁(1), \hat{V}′_{j*}(1), the receiver verifies the authenticity of each packet sequentially and then reconstruct the data stream at t=1. The verification steps are:

$$For j = 1 , {J}^{*} , {h}_{j}^{′} ( 1 ) = H ( {{V}^{⋒}}_{j}^{′} ( 0 ) )$$

$${V}^{′} = {\sum }_{j = 1}^{{J}^{*}} ( {h}_{j}^{′} ( 1 ) - {h}_{j} ( 1 ) ) \qquad ( 7 )$$

It then continues the same steps for t=2 to T, if v′=0, until the session ends. The initial playback delay is τ=τ₀+τ₁ where τ₀ equals the time for receiving \hat{V}′₀(0), \hat{V}′₀(1), \hat{V}′₁(1), . . . , \hat{V}′_{J*}(1) and verifying them.

On a server miss, the server notifies the client and sends a list of other available servers to the client.

When multiple packets per base layer is created, a simple solution is to authenticate all the packets in the base layer together since the base layer is rendered useless in the absence of any packet. Alternatively, a 3D instead of a 2D MDBAFV can be used.

Denote Msd the maximum number of different scales and Mac the maximum number of different access levels, without considering temporal scalability, a Msd=J+1 and Mac=J+2 are achieved using MDBAFV. Compared to signsimulcast, a total number of

$${\sum }_{j = 1}^{J} ( j \cdot T \cdot ( m + m 0 ) ) - T \cdot m 0 - m bits \qquad ( 8 )$$

storage space are saved at the server.

Compared to the naïve stream authentication with signsimulcast approach, MDBAFV saves a total number of

$${\sum }_{j = 1}^{J + 1} j \cdot T - 1 \qquad ( 9 )$$

public key encryption and public key decryption operations.

Loss resilient scalability using double forward authentication (DFA): With a suitable one way hash algorithm, MDBAFV is efficient enough to allow authentication on the fly without introducing significant delays. However, in the presence of random packet loss (when the media data stream is transmitted through lossy channels) the forward authentication chain is broken if a base layer packet is lost and hence, authentication is not possible after a packet loss. To solve this problem, we discuss two approaches namely signature caching (SC) and double forward authentication (DFA.) In SC, hash values hⱼ(t) of the entire data stream are grouped into clusters, packetized, cached in proxy or the server, and sent to the client before any medium data stream packet. Retransmission maybe used to guarantee the reception of all authentication value packets. The drawback is the longer initial delay and the large buffer size requirement at the receiver. This is especially vital for mobile devices. Alternatively, the authentication value packets are not sent to the client initially. Rather, upon notification of packet (\hat{v}′ⱼ(t)) loss, the proxy or the server retransmits the corresponding hash cluster packet to the client where hⱼ (t is extracted for verification of authenticity of the next packet/s. The disadvantage, however, is the retransmission for the authentication value packet that may results in discontinuity in video/audio playback. Further, extra memory at either the server or the proxy for hash caching and extra computing power at either the proxy or the client are needed, especially in an insecure environment where encryption is required. To reduce the average delay per packet, the client can save the retransmitted hash cluster in the buffer for subsequent packets. Nevertheless, this introduces additional memory requirement at the client side.

DFA is a modified MDBAFV to provide loss resilient capability. It does not require hash caching. Instead, the hash of a packet \hat{v}ⱼ(t) is stored in not one but two packets: \hat{v}ⱼ(t−1) and \hat{v}ⱼ₋₁(t) for enhancement layer packets and \hat{v}₀(t−1) and \hat{v}₀(t−t′) for base layer packets, proceeding to \hat{v}ⱼ(t) with t′>1 and t−t′ sufficiently close to t−1 for minimum delay.

$$For t = T to 1$$

$$For j = J to 0$$

$$\begin{matrix}\{ \begin{matrix}{{V}^{⋒}}_{j}^{′} ( t ) = < {{V}^{⋒}}_{j} ( t ) , {V}_{0 o} > , if j = J and t = T \\ {{V}^{⋒}}_{j}^{′} ( t ) = < {{V}^{⋒}}_{j} ( t ) , {h}_{j} ( t + 1 ) > , if j = J and t \neq T \\ {{V}^{⋒}}_{j}^{′} ( t ) = < {{V}^{⋒}}_{j} ( t ) , {h}_{j + 1} ( t ) , {V}_{0} > , if j = 0 and t = T \\ {{V}^{⋒}}_{j}^{′} ( t ) = < {{V}^{⋒}}_{j} ( t ) , {h}_{j + 1} ( t ) , {h}_{j} ( t + 1 ) , {h}_{j} ( t + {t}^{′} ) > , if j = 0 and t \neq T \\ {{V}^{⋒}}_{j}^{′} ( t ) = < {{V}^{⋒}}_{j} ( t ) , {h}_{j + 1} ( t ) , {h}_{j} ( t + 1 ) > , otherwise\end{matrix} & ( 3 \text{-} 2 ) \\ {h}_{j} ( t ) = H ( {{V}^{⋒}}_{j}^{′} ( t ) ) \\ {h}_{0} = < {h}_{0} ( 1 ) , J , m , m 0 > & ( 4 \text{-} 2 ) \\ {{V}^{⋒}}_{0}^{′} ( 0 ) = S = < {h}_{0} , Sign ( {h}_{0} , {K}_{enc} ) > & ( 5 \text{-} 2 )\end{matrix}$$

The verification procedure is the same at that in MDBAFV, except some added steps for loss resilient verification. At t, receiver extracts both hⱼ(t+1) and hⱼ(t+t′) for j=0 or hⱼ(t+1) and hⱼ₊₁(t) for j>0. When \hat{v}ⱼ(t−1) is lost, the receiver retrieves hⱼ(t) from the buffer, which was extracted from \hat{v}ⱼ(t−t′) for j=0 or \hat{v}ⱼ₋₁(t) for j>0 and continues verification and playback robustly. Noticeably, besides the need for (t′−1) number of hash values, i.e., ((t′−1)×m0+m0)=(t′×m0) bits buffered in the receiver at all time, each packet size is subsequently increased from (m+m0) bits to (m+2×m0) bits. DFA does not change the channel and device scalability of MDBAFV with Msd=J+1 and Mac=J+2. Assume Pₚ denotes the average packet loss rate of the network. Apparently, the probability of both \hat{v}₀(t−1) and \hat{v}₀(t−t′) or \hat{v}ⱼ(t−1) and \hat{v}ⱼ₋₁(t) are lost equals to the probability Pₑ of a non-recoverable loss that results in an unverifiable packet causing transmission/playback interruption. If we define LRS=1−Pₑ the loss resilient capability (scalability) of the scheme, the loss resilient scalability of DFA is increased from 0 of MDBAFV to LRS=1−(T(T−1)·Pₚ²). That is DFA trades loss resilient capability with packet size and buffer size.

Performance consideration: Now we look at the memory and computational overhead at server and client for authentication to ensure the feasibility of MDBAFV.

Server:

Computational Cost (CCₛ):

MDBAFV: The computational cost at the server includes the cost for computing the one way hash for each packet: τₕ, and that for generating the signature of the first packet: τₛ. Therefore the total cost is:
CCₛ|_{MDBAFV}=T(J+1)τₕ+τₛ
Clearly, the faster the one way hash and the public key encryption are, the lower the computational cost will be.

DFA: Although there seems to have no additional one way hash or digital signature generated for DFA, compared to that of MDBAFV, because the packet overhead is increased from m0 to 2m0, in most cases either T(J+1) or τₕ will be increased. Hence,
CCₛ|_{DFA}>CCₛ|_{MDBAFV}

Additional Storage Space Needed (CHₛ):

MDBAFV: Likewise, the storage space increase at the server side include the one way hash appended/embedded in each packet plus that for the additional packet \hat{v}′₀(0)=S. Hence the additional storage space needed for each medium is:
CHₛ|_{MDBAFV}=T(J+1)×m0+m

DFA: Similarly,
CHₛ|_{DFA}=2T(J+1)×m0+m

Client:

Computational Cost (CC_{c}):

MDBAFV: Initial cost: τ=τ₀, the time for receiving the first packet \hat{v}′₀(0), extracting the digital signature, and verifying it. Per packet cost: CC_{c}|_{MDBAFV}=τ=τₚ, the time for extracting the embedded hash value of the next packet plus the time for calculating the one way hash of the current packet and verifying it.

DFA: CC_{c}|_{DFA}=τ′ₚ, the time for extracting the two embedded hash value plus the time for calculating the one way hash of the current packet and verifying it. Clearly, τ′ₚ is slightly larger than τₚ with a negligible amount. Noticeably, the per packet cost at the client is largely dependent on the cost for computing the one way hash and the initial delay of each streaming medium playback is determined by that of the digital signature which includes the public key decryption and the one way hash two components. Hence for mobile device where battery power is limited, it is important to choose a fast one way hash algorithm. In Section 4, we show that it is possible to find such algorithms, with as little as several addition operations, to make MDBAFV and DFA feasible for mobile devices. Comparing MDBAFV and DFA to a naïve stream authentication algorithm where each packet is signed using a public key crypto algorithm such as RSA, the computational overhead at the mobile device is reduced from O(n²) for multiplication plus O(n) for exponentiation in the naïve algorithm to O(1) for MDBAFV and DFA per packet, with n the length of the block. Only a one time O(n²) for multiplication plus O(n) for exponentiation is introduced for the initial cost that leads to an acceptable delay for playback at the mobile device (client).

Additional Storage Space Needed (CH_{c}):

MDBAFV: CH_{c}|_{MDBAFV}=m0, the size for caching the hash value of the next packet for verification. Since m0 is a small constant, e.g., 128 bit (<<xMB, the memory size of a typical multimedia enabled mobile device today) it is generally feasible for any mobile devices or any other devices.

DFA: As we discussed above in relation to DFA, CH_{c}|_{DFA}=(t′×m0) bits, t′>1. When the mobile device memory size is small, it is generally desirable to choose a small t′. However, when the probability of a consecutive packet loss is high, LRS maybe reduced. In other words, the larger t′ is, the higher LRS is. It is a trade off between loss resilient scalability and client buffer size.

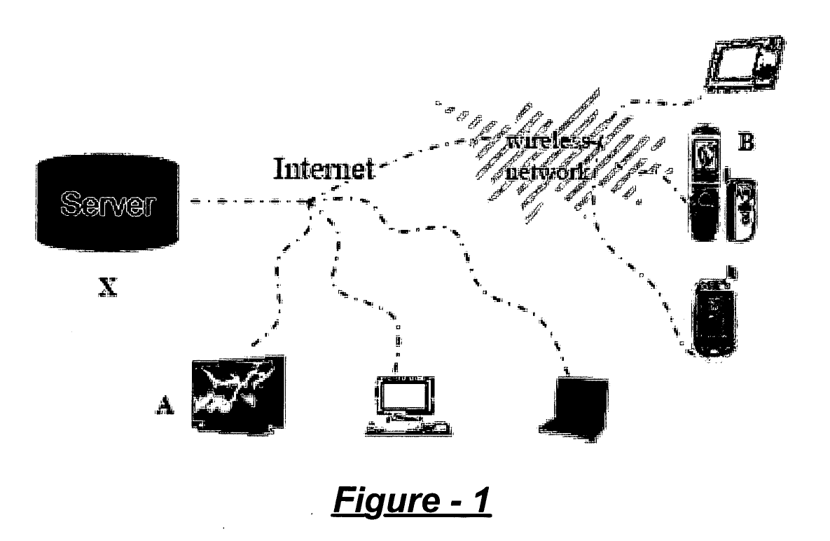

Simulation: We set up a simple test bed similar to that was shown in FIG. 1. We set J=3, J*=2, T=300, and m=512. The streaming data rate is about 2 Mbps and the packet loss rate of 10⁻³ is used. We employ a fast one way hash algorithm introduced in [6]. Because the computing power needed to calculated each hⱼ(t) is only a constant number C additions[6], the requirement of the receiver having the processing power to compute the one way hash faster than the incoming packet streaming rate is easily achieved.

TABLE 1

| | signsimulcast | MDBAFV | DFA1 |
|---|---|---|---|
| Msd | 4 | 4 | 4 |
| Mac | 5 | 5 | 5 |
| Chs(KB) | 240 | 19 | 38 |
| Chc(KB) | 0 | 0.016 | 0.032 |
| | | | (t′ = 2) |
| LRS | 1 | 0 | 91.3 |

An interesting improvement on DFA is to use multi-path (virtual or real) transmission to transmit each layer of the medium data stream in different path [5] and use multiple description coding [6] for the enhancement layer partition. The result is that Pₑ is greatly reduced and hence better QoS is achieved. This is because if unreliability occurs at path j, hⱼ₊₁ (t) is retrieved from \hat{v}ⱼ₊₁(t−1), the packet delivered through path j+1. If at time t, dynamic channel condition introduces transmission errors through several channels, hⱼ(t+1) can be retrieved from \hat{v}ⱼ₋₁(t+1) delivered at time t+1 instead. When base layer reliable transmission can be guaranteed, the two directional hash value embedding approach ensures higher loss resilient capability. When multiple description coding is used for the enhancement layer, the quality of the reconstructed video/audio depends on the number of enhancement layers received at time t, instead of the order of the enhancement layer j of the lost packet \hat{v}ⱼ(t). In other words, \hat{v}ⱼ₊₁(t), \hat{v}ⱼ₊₂(t), . . . can still be used for reconstruction. A total number of (J−1)≧(j−1) instead of (j−1) enhancement layers can be used to reconstruct the medium at time t.

Next, we looked at the visual quality of several 2˜3 mins long 15 frames/sec videos streaming to mobile devices. At the receiver, if the next frame is not reconstructed in time, we freeze the current frame until the next frame is available. When there is no transmission error, the overall visual quality (continuity and video frame quality) of the video is better when MDBAFV is used. This is because given the same bandwidth, same receiver device capability, and same time duration, there are more bits of V′ received by the client when using MDBAFV instead of DFA. In our case, we were able to transmit one more enhancement layer at some time intervals when using MDBAFV. This gives us higher PSNR, i.e., better visual quality in general. When the transmission channel is unreliable, that is, when packet loss presents, clearly, DFA out performs MDBAFV. The time of the first packet loss shall determine the video cut off time for MDBAFV. We also compare the performance of DFA with signsimulcast. We use a simple copy previous frame error conceal algorithm on packet loss for signsimulcast. On average a 2.1 dB PSNR increase was achieved using DFA.

Discussion:

Security. It can be shown that if all the components of the above proposed MDBAFV and DFA schemes are secure, MDBAFV and DFA are secure. Here, we shall give a brief proof of their security.

Let a MDBAFV(DFA) system be a five tuple (I, I′, K, S, V) where I and I′ are finite sets of host and authenticated media data streams respectively, K is a finite set of possible keys, and S and V are the signing and verification algorithms. Let H be a collision-resistant hash function and Sign be a secure public key digital signature function. Assume MDBAFV(DFA) is not secure. That means there ∃ f, an algorithm that can forge (I, I′, K, S, V) using an adaptive chosen message attack. 1. Assume for z=1, Z streams, _{f}V′₀(0)≠V²′₀(0) and _{f}V′ⱼ(t)=V²′ⱼ(t) for t≠0 and j≠0, ∵_{f}V′₀(0)=<h₀, Sign(h₀,K_{enc})>, h₀=<h₀(1), J, m, m0>, and hⱼ(t)=H(\hat{v}′ⱼ(t)), ∵either ∃ _{f}K_{enc}≠K_{enc} or _{f}V′₀(0)=V²′₀(0); 2. Assume for z=1, Z streams, _{f}V′₀(0)=V²′₀(0) and ∃ j&t, <f\hat{v}ⱼ(t), H(f\hat{v}′ⱼ(t+1))>=<\hat{v}Vⱼ(t), H(\hat{v}′ⱼ(t+1))>, ∵either H(f\hat{v}′ⱼ(t+1))≠H(\hat{v}′ⱼ(t+1)) or f\hat{v}ⱼ(t)≠\hat{v}ⱼ(t) [symbol] _{f}V′₀(0)≠V²′₀(0); Since each conclusion contradicts to at least one assumption, we claim MDBAFV (DFA) is secure. Intrinsically, MDBAFV and DFA take advantage of the following characteristics to ensure the security: V′₀(0)=S is secure and V′₀(0) is a function of each and every subsequent packet data stream and their hash values of all layers and all time instances.

Packet size overhead reduction: One drawback of the proposed DFA scheme is the packet size overhead introduced due to double hash value embedding. To reduce packet size overhead, we employ data hiding techniques to embed the authentication value h into the content data stream. The tradeoff, however, is the additional computational overhead at both the server and the client.

Content authentication for increased scalability The idea is to extract a content invariant feature of the multimedia data stream and authenticate the invariant feature instead of the full data stream. The advantage lies in its added scalability. However, there is no known technique to obtain robust enough invariant features for such applications. Furthermore, extra computational overhead at both the server and client may incur.

Summary: We presented MDBAFV SMMA algorithms that are suitable for streaming media authentication. Scalability to heterogeneous network is achieved. With DFA an improved MDBAFV, loss resilient scalability is achieved.

To minimize delay and conserve bandwidth, multimedia proxy can be used to perform data caching for clients to access the cached video from their nearby proxies. To deal with the variations in quality during subsequent playback, one possible approach is caching a subset of the multimedia data stream Vₚ⊂V and then to deliver a subset of the cached data stream V_{f}⊂Vₚ to receiver, or by simultaneously playing those from the proxy Vₚ⊂V and fetching additional data stream Vᵣₐ⊂V−ₚ⊂V, where Vₚ+V−ₚ=V from the server [7,8]. The proposed MDBAFV and DFA can be easily adapted for proxy caching based approaches to provide better QoS.

### REFERENCES

[1] B. Schneier, Applied Cryptography, John Wiley & Sons, 1996.
[2] J. Liu and B. Li, Optimal Stream Replication for Video Simulcasting, IEEE ICNP'02, pp. 190-191, Paris, November 2002.
[3] R. Gennaro and P. Rohatgi, “How to sign digital streams”, Information and Computation, vol 165 no 1, pp 100-116, 2001
[4] M. Mihaljevic, Y. Zheng, H. Imai, “A family of fast dedicated one way hash functions based on linear cellular automata over GF(q)”, IEICE Trans Fundamentals, vol E82-1, no 1, January, 1999
[5] J. Zhou, H.-R. Shao, C. Shen, M.-T. Sun, “Multi-path Transport of FGS Video”, MERL TR-2003-10 February 2003
[6] V. K. Goyal, “Multiple description coding: compression meets the network”, IEEE Signal Processing Magazine, September, 2001
[7] Sen, J. Rexford, and D. Towsley, “Proxy prefix caching for multimedia streams,” in Proc. of INFOCOM, New York, N.Y., March 1999
[8]R. Rejaie, M. Handley, H. Yu, D. Estrin, “Proxy Caching Mechanism for Multimedia Playback Streams in the Internet”, in Proc, the 4th International Web Caching Workshop, San Diego, Calif., March 1999

The description of the invention is merely exemplary in nature and, thus, variations that do not depart from the gist of the invention are intended to be within the scope of the invention. Such variations are not to be regarded as a departure from the spirit and scope of the invention.

1. A scalable streaming media authentication method, comprising:
placing a single authenticated media data stream at a server;
transmitting the single authenticated media data stream to clients; and
jointly designing coding, packetization, and authentication in a scalable fashion, structuring the media data stream at the server using layered organization, such that the original data stream to be transmitted at each time interval is split into a base layer, which contains the most essential information for minimum acceptable playback quality, and J enhancement layers with optional enhancement information, wherein \hat{v}=<\hat{v}(1), \hat{v}(2), . . . , \hat{v}(T)> denotes the structured media data stream, to be delivered at time t=t₁, t₂, . . . t_{T}, \hat{v}(t) is partitioned into a base layer \hat{v}_{b}(t)=\hat{v}₀(t) and J enhancement layer segments (packets) \hat{v}j(t), each of size mbits, in a priority based order according to:
$$\begin{matrix}{V}^{⋒} = < {V}^{⋒} ( 1 ) , {V}^{⋒} ( 2 ) , … , {V}^{⋒} ( T ) > \\ = \vert \begin{matrix}{{V}^{⋒}}_{0} ( 1 ) & {{V}^{⋒}}_{0} ( 2 ) & … & {{V}^{⋒}}_{0} ( T ) \\ {{V}^{⋒}}_{1} ( 1 ) & {{V}^{⋒}}_{1} ( 2 ) & … & {{V}^{⋒}}_{1} ( T ) \\ ⋮ & ⋮ & … & ⋮ \\ {{V}^{⋒}}_{J} ( 1 ) & {{V}^{⋒}}_{J} ( 2 ) & … & {{V}^{⋒}}_{J} ( T )\end{matrix} \vert\end{matrix} \qquad ( 1 )$$

2. The method of claim 1, further comprising generating the authenticated scalable media data stream at the server as a function F(\hat{v}, K_{enc}, H, Sign), wherein \hat{v} denotes a structured version of V, which denotes the original media data stream at the server, H denotes a collision resistant crypto hash function, Sign denotes a secure digital signature function, and K_{enc} denotes an encryption key.

3. The method of claim 2, further comprising generating the authenticated scalable media data steam:
$${{V}^{⋒}}^{′} = < S , {{V}^{⋒}}^{″} > \\ {{V}^{⋒}}^{″} = \vert \begin{matrix}{{V}^{⋒}}_{0}^{′} ( 1 ) & {{V}^{⋒}}_{0}^{′} ( 2 ) & … & {{V}^{⋒}}_{0}^{′} ( T ) \\ {{V}^{⋒}}_{1}^{′} ( 1 ) & {{V}^{⋒}}_{1}^{′} ( 2 ) & … & {{V}^{⋒}}_{1}^{′} ( T ) \\ ⋮ & ⋮ & … & ⋮ \\ {{V}^{⋒}}_{J}^{′} ( 1 ) & {{V}^{⋒}}_{J}^{′} ( 2 ) & … & {{V}^{⋒}}_{J}^{′} ( T )\end{matrix} \vert \qquad ( 2 )$$
as follows where S is the server signature:
Perform:
$$For t = T to 1$$
$$For j = J to 0$$
$$\begin{matrix}\{ \begin{matrix}{{V}^{⋒}}_{j}^{′} ( t ) = 〈 {{V}^{⋒}}_{j} ( t ) , {V}_{0} 〉 , if j = J and t = T \\ {{V}^{⋒}}_{j}^{′} ( t ) = 〈 {{V}^{⋒}}_{j} ( t ) , {h}_{j} ( t + 1 ) 〉 , if j = J and t \neq T \\ {{V}^{⋒}}_{j}^{′} ( t ) = 〈 {{V}^{⋒}}_{j} ( t ) , {h}_{j + 1} ( t ) , {V}_{0} 〉 , if j = 0 and t = T \\ {{V}^{⋒}}_{j}^{′} ( t ) = 〈 {{V}^{⋒}}_{j} ( t ) , {h}_{j + 1} ( t ) , {h}_{j} ( t + 1 ) 〉 , if j = 0 and t \neq T \\ {{V}^{⋒}}_{j}^{′} ( t ) = 〈 {{V}^{⋒}}_{j} ( t ) , {h}_{j + 1} ( t ) 〉 , otherwise\end{matrix} & ( 3 \text{-} 1 ) \\ {h}_{j} ( t ) = H ( {{V}^{⋒}}_{j}^{′} ( t ) ) \\ {h}_{0} = 〈 {h}_{0} ( 1 ) , J , m , m 0 〉 & ( 4 \text{-} 1 ) \\ {{V}^{⋒}}_{0}^{′} ( 0 ) = S = 〈 {h}_{0} , Sign ( {h}_{0} , {K}_{enc} ) 〉 . & ( 5 \text{-} 1 )\end{matrix}$$

4. The method of claim 3, further comprising:
sending the data stream packet by packet to the client, wherein at time tₜ, the packets are sent in the order of \hat{v}′₀(t), \hat{v}′₁(t), . . . ;
receiving and verifying the authenticity of \hat{v}′₀(0) according to:
v=V(\hat{v}′₀(0),K_{dec}) (6);
extracting h₀(1) if v=1;
starting reconstruction upon receiving the second packet \hat{v}′₀(1) and verifying that \hat{v}′₀(1) is authentic using h₀(1) extracted from \hat{v}′₀(0) and h′₀(1) calculated with equation (4-1), wherein V is a verification function and K_{dec} is a decryption key.

5. The method of claim 4, further comprising;
grouping hash values hⱼ(t) of the entire data stream into clusters;
packetizing the clusters; and
sending the clusters to a client.

6. The method of claim 5, further comprising:
caching the clusters in proxy or at the server;
retransmitting the clusters to guarantee reception of all clusters.

7. The method of claim 5, further comprising sending the clusters to the client before any medium data stream packets.

8. The method of claim 5, further comprising:
caching the clusters in proxy or at the server;
receiving notification of packet (\hat{v}′ⱼ(t)) loss;
retransmitting the corresponding hash cluster packet to the client where hⱼ(t) is extracted for verification of authenticity of the next packet/s.

9. The method of claim 8, further comprising saving the retransmitted hash cluster in client buffer for subsequent packets.

10. The method of claim 4, further comprising:
when Bᵣ>B_{b}, fetching the base layer plus some of the enhancement layer data stream at the client, wherein J*<J additional enhancement layers are fetched from the server;
upon receiving the second to the (J*+1)th packets \hat{v}′₀(1), \hat{v}′₁(1), \hat{v}′_{j*}(1), verifying the authenticity of each packet sequentially and then reconstructing the data stream at t=1, wherein the verification steps are:
$$For j = 1 , {J}^{*} , {h}_{j}^{′} ( 1 ) = H ( {{V}^{⋒}}_{j}^{′} ( 0 ) )$$
$${V}^{′} = {\sum }_{j = 1}^{{J}^{*}} ( {h}_{j}^{′} ( 1 ) - {h}_{j} ( 1 ) ) . \qquad ( 7 )$$
continuing the verification steps for t=2 to T, if v′=0, until the session ends.

11. The method of claim 2, further comprising:
storing a hash of a packet \hat{v}ⱼ(t) in two packets: \hat{v}ⱼ(t−1) and \hat{v}ⱼ₋₁(t) for enhancement layer packets and \hat{v}₀(t−1) and \hat{v}₀(t−t′) for base layer packets, proceeding to \hat{v}ⱼ(t) with t′>1 and t−t′ sufficiently close to t−1 for minimum delay;
generating the authenticated scalable media data steam:
$${{V}^{⋒}}^{′} = 〈 S , {{V}^{⋒}}^{″} 〉$$
$${{V}^{⋒}}^{″} = \vert \begin{matrix}{{V}^{⋒}}_{0}^{′} ( 1 ) & {{V}^{⋒}}_{0}^{′} ( 2 ) & ⋯ & {{V}^{⋒}}_{0}^{′} ( T ) \\ {{V}^{⋒}}_{1}^{′} ( 1 ) & {{V}^{⋒}}_{1}^{′} ( 2 ) & ⋯ & {{V}^{⋒}}_{1}^{′} ( T ) \\ ⋮ & ⋮ & ⋯ & ⋮ \\ {{V}^{⋒}}_{J}^{′} ( 1 ) & {{V}^{⋒}}_{J}^{′} ( 2 ) & ⋯ & {{V}^{⋒}}_{J}^{′ } ( T )\end{matrix} \vert \qquad ( 2 )$$
as follows where S is the server signature:
Perform:
$$For t = T to 1$$
$$For j = J to 0$$
$$\begin{matrix}\{ \begin{matrix}{{V}^{⋒}}_{j}^{′} ( t ) = 〈 {{V}^{⋒}}_{j} ( t ) , {V}_{0 o} 〉 , if j = J and t = T \\ {{V}^{⋒}}_{j}^{′} ( t ) = 〈 {{V}^{⋒}}_{j} ( t ) , {h}_{j} ( t + 1 ) 〉 , if j = J and t \neq T \\ {{V}^{⋒}}_{j}^{′} ( t ) = 〈 {{V}^{⋒}}_{j} ( t ) , {h}_{j + 1} ( t ) , {V}_{0} 〉 , if j = 0 and t = T \\ {{V}^{⋒}}_{j}^{′} ( t ) = 〈 {{V}^{⋒}}_{j} ( t ) , {h}_{j + 1} ( t ) , {h}_{j} ( t + 1 ) {h}_{j} ( t + {t}^{′} ) 〉 , if j = 0 and t \neq T \\ {{V}^{⋒}}_{j}^{′} ( t ) = 〈 {{V}^{⋒}}_{j} ( t ) , {h}_{j + 1} ( t ) {h}_{j} ( t + 1 ) 〉 , otherwise\end{matrix} & ( 3 \text{-} 2 ) \\ {h}_{j} ( t ) = H ( {{V}^{⋒}}_{j}^{′} ( t ) ) \\ {h}_{0} = 〈 {h}_{0} ( 1 ) , J , m , m 0 〉 & ( 4 \text{-} 2 ) \\ {{V}^{⋒}}_{0}^{′} ( 0 ) = S = 〈 {h}_{0} , Sign ( {h}_{0} , {K}_{enc} ) 〉 . & ( 5 \text{-} 2 )\end{matrix}$$

12. The method of claim 11, further comprising:
sending the data stream packet by packet to the client, wherein at time tₜ, the packets are sent in the order of \hat{v}′₀(t), \hat{v}′₁(t), . . . ;
in the case that the bandwidth of the playback session at the receiver Br exceeds that of the base layer stream B_{b}, Bᵣ>B_{b}, when Bᵣ>B_{b}, fetching the base layer plus some of the enhancement layer data stream at the client, wherein J*<J additional enhancement layers are fetched from the server;
upon receiving the second to the (J*+1)th packets \hat{v}V′₀(1), \hat{v}′₁(1), \hat{v}′_{j*}(1), verifying the authenticity of each packet sequentially and then reconstructing the data stream at t=1, wherein the verification steps are:
$$For j = 1 , {J}^{*} , {h}_{j}^{′} ( 1 ) = H ( {{V}^{⋒}}_{j}^{′} ( 0 ) )$$
$${V}^{′} = {\sum }_{j = 1}^{{J}^{*}} ( {h}_{j}^{′} ( 1 ) - {h}_{j} ( 1 ) ) . \qquad ( 7 )$$
continuing the verification steps for t=2 to T, if v′=0, until the session ends;
at t, extracting both hⱼ(t+1) and hⱼ(t+t′) for j=0 or hⱼ(t+1) and hⱼ₊₁(t) for j>0;
when \hat{v}ⱼ(t−1) is lost, retrieving hⱼ(t) from the buffer, which was extracted from \hat{v}ⱼ(t−t′) for j=0 or \hat{v}ⱼ₋₁(t) for j>0.

13. The method of claim 12, further comprising:
using multi-path (virtual or real) transmission to transmit layers of the medium data stream in different paths; and
using multiple description coding for an enhancement layer partition.

14. A verification method for use with scalable media stream authentication, comprising:
receiving a structured media data stream packet by packet, wherein \hat{v}=<\hat{v}(1), \hat{v}(2), . . . , \hat{v}(T)> denotes the structured media data stream, to be delivered at time t=t₁, t₂, . . . t_{T}, \hat{v}(t) is partitioned into a base layer \hat{v}_{b}(t)=\hat{v}₀(t) and J enhancement layer segments (packets) \hat{v}ⱼ(t), each of size mbits, in a priority based order according to:
$$\begin{matrix}{V}^{⋒} = 〈 {V}^{⋒} ( 1 ) , {V}^{⋒} ( 2 ) , ⋯ {V}^{⋒} ( T ) 〉 \\ = \vert \begin{matrix}{{V}^{⋒}}_{0} ( 1 ) & {{V}^{⋒}}_{0} ( 2 ) & ⋯ & {{V}^{⋒}}_{0} ( T ) \\ {{V}^{⋒}}_{1} ( 1 ) & {{V}^{⋒}}_{1} ( 2 ) & ⋯ & {{V}^{⋒}}_{1} ( T ) \\ ⋮ & ⋮ & ⋯ & ⋮ \\ {{V}^{⋒}}_{J} ( 1 ) & {{V}^{⋒}}_{J} ( 2 ) & ⋯ & {{V}^{⋒}}_{J} ( T )\end{matrix} \vert\end{matrix} , \qquad ( 1 )$$
and at time tₜ, the packets are sent in the order of \hat{v}′₀(t), \hat{v}′₁(t), . . . ;
verifying the authenticity of \hat{v}′₀(0) according to:
v=V(\hat{v}′₀(0),K_{dec}) (6);
extracting h₀(1) if v=1; and
starting reconstruction upon receiving the second packet \hat{v}′₀(1) and verifying that \hat{v}′₀(1) is authentic using h₀(1) extracted from \hat{v}′₀(0) and h′₀(1) calculated according to:
hⱼ(t)=H(\hat{v}′ⱼ(t)),
wherein V is a verification function, H denotes a collision resistant crypto hash function, and K_{dec} is a decryption key.

15. The method of claim 14, further comprising:
when Bᵣ>B_{b}, fetching the base layer plus some of the enhancement layer data stream at the client, wherein J*<J additional enhancement layers are fetched from the server;
upon receiving the second to the (J*+1)th packets \hat{v}′₀(1), \hat{v}′₁(1), \hat{v}′_{j*}(1), verifying the authenticity of each packet sequentially and then reconstructing the data stream at t=1, wherein the verification steps are:
$$For j = 1 , {J}^{*} , {h}_{j}^{′} ( 1 ) = H ( {{V}^{⋒}}_{j}^{′} ( 0 ) )$$
$${V}^{′} = {\sum }_{j = 1}^{{J}^{*}} ( {h}_{j}^{′} ( 1 ) - {h}_{j} ( 1 ) ) . \qquad ( 7 )$$
continuing the verification steps for t=2 to T, if v′=0, until the session ends.

16. The method of claim 15, further comprising:
at t, extracting both hⱼ(t+1) and hⱼ(t+t′) for j=0 or hⱼ(t+1) and hⱼ₊₁(t) for j>0; and
when \hat{v}ⱼ(t−1) is lost, retrieving hⱼ(t) from a buffer, which was extracted from \hat{v}ⱼ(t−t′) for j=0 or \hat{v}ⱼ₋₁(t) for j>0.
